(19) United States
(12) Patent Application Publication
(10) Pub. No.: US 2017/0094234 A1
(43) Pub. Date: Mar. 30, 2017

(54) PROJECTION SYSTEM

(71) Applicant: CASIO COMPUTER CO., LTD., Tokyo (JP)

(72) Inventor: Toru TAKAHAMA, Tokyo (JP)

(73) Assignee: CASIO COMPUTER CO., LTD., Tokyo (JP)

(21) Appl. No.: 15/225,498

(22) Filed: Aug. 1, 2016

(30) Foreign Application Priority Data
Sep. 24, 2015 (JP) 2015-187013

(51) Int. Cl. H04N 9/31

(52) U.S. Cl. CPC H04N 9/3179; H04N 9/3141

(57) ABSTRACT

A projection system includes: an imaging unit configured to photograph a predetermined region; a projection unit configured to project an image on a first surface and a second surface different from the first surface; and a processor configured to control a projection by the projection unit based on a state of a person photographed by the imaging unit.

### BACKGROUND OF THE INVENTION

Field of the Invention

The present invention relates to a projection system.

Description of the Related Art

Recently, there has been proposed a projection system which includes a projection unit, such as a projector, and projects an image on various places.

For example, JP 2014-51833 A discloses an automatic door system including a projector which projects the opening width of an automatic door on a floor surface.

On the other hand, JP 2010-160780 A and JP 2007-34585 A disclose a display system which includes a display unit, an imaging unit photographing a person near it, distinguishes an attribute of the photographed person, and displays an advertisement suitable for the attribute on a display unit.

However, with conventional display systems, it is difficult to obtain effects of distinguishing a person interested in a merchandise item, a service, an exhibit, or the like, and guiding the interested person to a store or an exhibition place where the merchandise item, the service, the exhibit, or the like is available.

The present invention has been made in view of the above problems, and is to provide a projection system capable of distinguishing a person interested in a merchandise item, a service, an exhibit, or the like, and guiding the interested person to a store or an exhibition place where the merchandise item, the service, the exhibit, or the like is available.

### SUMMARY OF THE INVENTION

According to an embodiment of the present invention, there is provided a projection system including: an imaging unit configured to photograph a predetermined region; a projection unit configured to project an image on a first surface and a second surface different from the first surface; and a processor configured to control a projection by the projection unit based on a state of a person photographed by the imaging unit.

### BRIEF DESCRIPTION OF THE DRAWING

FIG. 1 is a perspective view illustrating a projection system according to a first embodiment of the present invention;

FIG. 2 is a perspective view illustrating an entire first projection apparatus when viewed from the left side direction;

FIG. 3 is a perspective view illustrating the entire first projection apparatus when viewed from the front direction;

FIG. 4 is a perspective view illustrating the first projection apparatus taken along the line A-A of FIG. 2;

FIG. 5 is a block diagram illustrating a control configuration of the first projection apparatus;

FIG. 6 is a flowchart explaining operations of the projection system according to the first embodiment of the present invention;

FIG. 7 is a perspective view illustrating a projection system according to a second embodiment of the present invention;

FIG. 8 is a flowchart explaining operations of the projection system according to the second embodiment of the present invention;

FIG. 9 is a perspective view illustrating a projection system according to a third embodiment of the present invention;

FIG. 10 is a flowchart explaining operations of the projection system according to the third embodiment of the present invention;

FIG. 11 is a side view illustrating a projection system according to a fourth embodiment of the present invention;

FIG. 12A is a diagram illustrating an automatic door being closed when viewed from the outside of a store, and FIG. 12B is a diagram illustrating the automatic door being opened when viewed from the outside of the store; and

FIG. 13 is a flowchart explaining operations of the projection system according to the fourth embodiment of the present invention.

### DETAILED DESCRIPTION OF THE PREFERRED EMBODIMENT

### First Embodiment

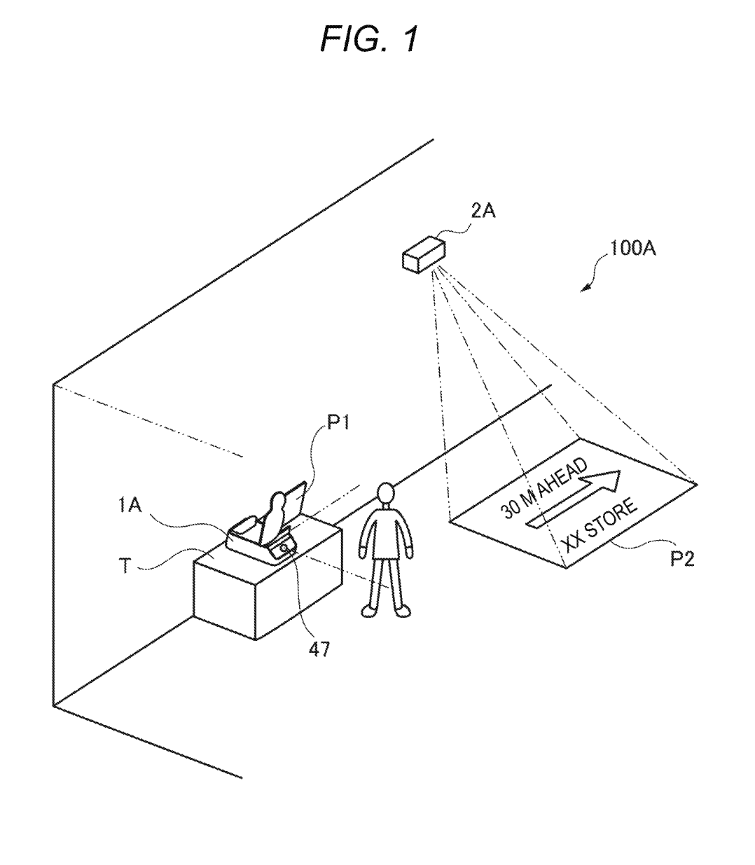

Hereinafter, a projection system 100A according to a first embodiment of the present invention will be described with reference to FIGS. 1 to 6.

FIG. 1 is a perspective view illustrating the projection system 100A according to the first embodiment of the present invention. The projection system 100A illustrated in FIG. 1 is installed in a commercial facility, such as a shopping mall, and has functions to display an advertisement of a merchandise item or a service, to distinguish a person interested in the advertisement, and to guide the person to a store where the merchandise item or the service is available.

Specifically, the projection system 100A in the present embodiment includes a first projection apparatus 1A (a first projection unit) which projects an image on a first surface P1, a second projection apparatus 2A (a second projection unit) which projects an image on a second surface P2 different from the first surface P1, and a camera 47 (an imaging unit) which photographs a person viewing the image from the first projection apparatus 1A.

Note that, the camera 47 is provided on the first projection apparatus 1A in the present embodiment, but may be provided separately from the first projection apparatus 1A.

[First Projection Apparatus]

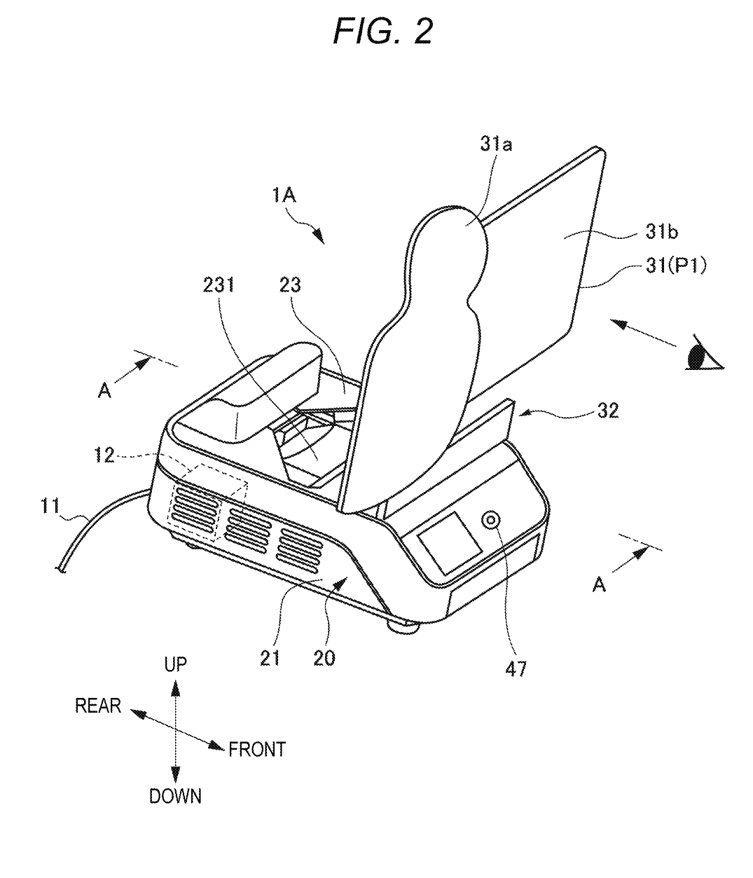

Next, the first projection apparatus 1A will be described with reference to FIGS. 2 to 4. The first projection apparatus 1A is installed on a table T as illustrated in FIG. 1, and configured to project image content, such as a merchandise explanation, on a screen 31 (a first surface P1) as illustrated in FIGS. 2 to 4.

Note that, the screen 31 in the present embodiment is suitable for reproducing content for a person to explain a merchandise item, and includes, as illustrated in FIG. 2, a three-dimensionally curved first screen region 31a on which a person image is to be projected, and a flat second screen region 31b on which an image, such as a merchandise explanation, is to be projected, but the shape or the like of the screen 31 is not limited to these.

As illustrated in FIG. 2, the first projection apparatus 1A includes a case 20 having a substantially rectangular box shape as a whole.

The main power of the first projection apparatus 1A is commercial power, and the first projection apparatus 1A includes a power cord 11 including a plug (not illustrated) to receive power from the commercial power, and a power unit 12 which converts AC power into DC power.

The screen 31 is exchangeably attached through a screen attaching part 32 at one end (the right end in FIG. 2) of the case 20, and can be exchanged for a screen 31 having a suitable shape according to content.

Note that, it is assumed that when the case 20 is placed on the table T or the like, the upper side thereof is the upper side, the screen 31 side is the front side, and the side opposite to the screen 31 side is the rear side in the following description.

The case 20 includes a side plate 21 which encloses all four sides and has an opening on the upper side.

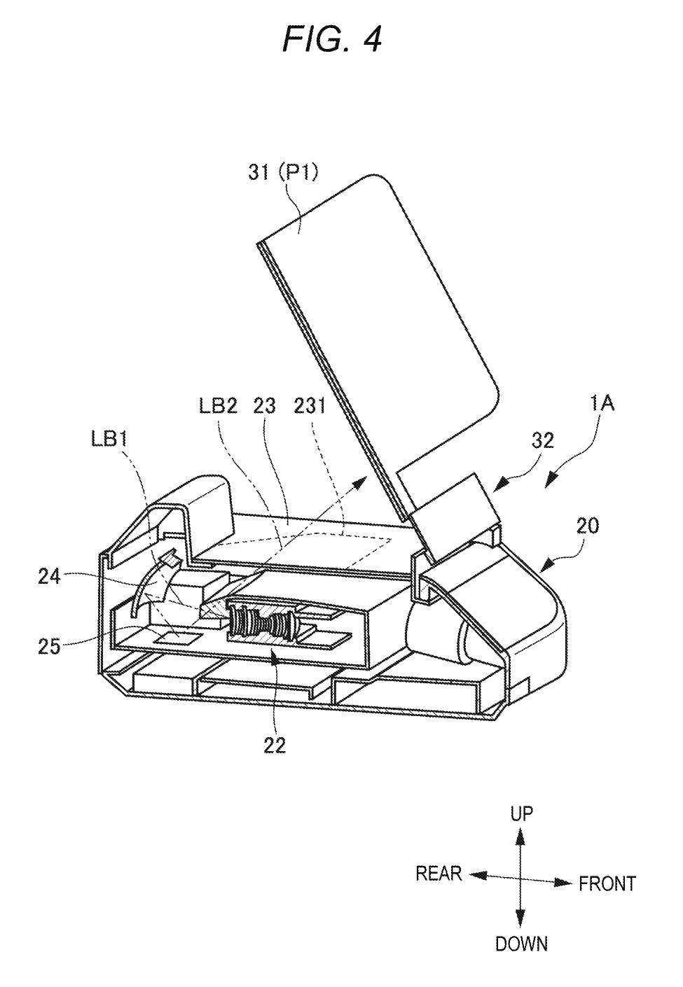

As illustrated in FIG. 4, a panel 23 is attached to cover the opening, and the center of the panel 23 is a transparent part 231 which transmits light.

Note that, the other part of the panel 23 except for the transparent part 231 is printed in black or the like so that the inside of the case 20 cannot be seen in the present embodiment, but the panel 23 is not limited to this, and the whole part of the panel 23 may be transparent.

As illustrated in FIG. 4, a projector 22, which generates projection light and emits the light toward the rear of the case 20, is provided in the substantially center of the inside of the case 20.

Furthermore, a first mirror 24 having a concave reflective surface is provided behind the case 20. The first mirror 24 reflects the projection light from the projector 22 toward a second mirror 25 having a flat reflective surface, and the second mirror 25 reflects the projection light toward the screen 31.

Thus, projection light (image) LB1 emitted from the projector 22 is reflected at the first mirror 24 downward, reflected at the second mirror 25 upward, passes through the transparent part 231 of the panel 23, and is projected on the screen 31 provided outside the case 20 (projection light LB2).

The screen 31 is formed by, for example, sticking, on the rear side of a translucent plate, such as an acrylic plate, formed in an arbitrary shape, a rear-projection film screen on which a film Fresnel lens is laminated.

Thus, the projection light (image) LB2 projected toward the rear side of the screen 31 from an oblique lower direction is refracted by the Fresnel lens, and the projection direction of the light is changed to the front side of the screen 31.

Since light scattering particles are dispersed in the acrylic plate in order for projection light passing through the acrylic plate to be clearly recognized as an image, the image is displayed on the acrylic plate. Thus, the projected image can be viewed when the screen 31 is viewed from the front side of the screen 31 as illustrated in FIG. 2.

Furthermore, the screen 31 on which the image is to be projected is rotatably supported by the screen attaching part 32. The screen 31 is raised when used, and laid down to the case 20 side when not used.

Thus, the screen 31 can be stored by being laid down to the case 20 side so that the screen 31 does not obstruct a carrying person when the first projection apparatus 1A is moved.

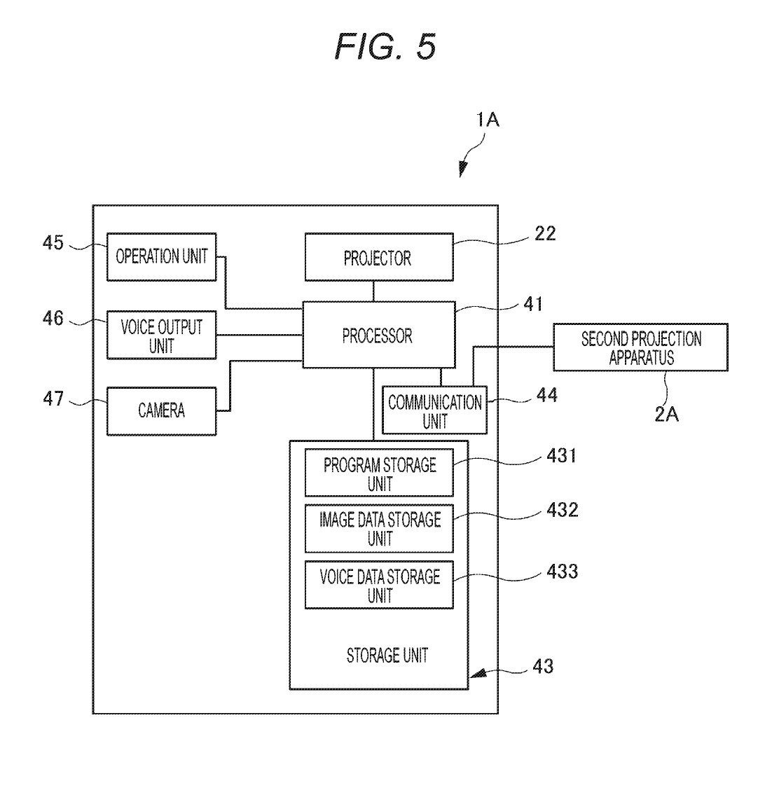

Next, the control configuration of the first projection apparatus 1A will be described with reference to the block diagram in FIG. 5.

As illustrated in FIG. 5, the first projection apparatus 1A includes, in addition to the above projector 22, a processor 41, a storage unit 43, a communication unit 44, an operation unit 45, a voice output unit 46, and a camera 47. The projector 22, the storage unit 43, the communication unit 44, the operation unit 45, the voice output unit 46, and the camera 47 are connected with the processor 41.

The processor 41 includes a central processing unit (CPU) which executes various programs stored in the storage unit 43 to perform predetermined calculations and to control the units, and a memory which is a work area when the programs are executed (both of which are not illustrated).

The processor 41 in the present embodiment controls not only the operations of the first projection apparatus 1A but also the operations of the projection system 100A in cooperation of the programs stored in a program storage unit 431 of the storage unit 43.

Note that, the operations of the projection system 100A are controlled by the processor 41 of the first projection apparatus 1A in the present embodiment, but may be controlled by a separately added processor.

The projector 22 converts image data output from the processor 41 into video light and emits the video light toward the screen 31.

As the projector 22, for example, the digital light processing (DLP) (registered trademark) projector using a digital micromirror device (DMD) is applicable. The DMD is a display element which forms a light image by reflection light by quickly switching on and off each tilt angle of a plurality of micro mirrors (in the case of XGA, width 1024 pixels×length 768 pixels) arranged in an array and thereby performing a display operation.

The storage unit 43 is constituted by an HDD, a non-volatile semiconductor memory, or the like, and includes the program storage unit 431, an image data storage unit 432, and a voice data storage unit 433.

For example, the program storage unit 431 stores a system program and various processing programs which are to be executed by the processor 41, data necessary for executing the programs, and the like.

The image data storage unit 432 stores image data and the like to be displayed when content is reproduced.

The voice data storage unit 433 stores text data for output of the sound of the content.

The communication unit 44 enables communication with, for example, an external device.

In the present embodiment, the communication unit 44 is used when the first projection apparatus 1A sends a projection start signal or a projection stop signal to the second projection apparatus 2A (see FIG. 1).

Note that, a specific communication method of the communication unit 44 is not particularly limited, and may be, for example, wireless connection, such as a wireless LAN, the Bluetooth (registered trademark), or the NFC, or wired connection using a USB cable or the like.

The operation unit 45 is to change the setting of content, and constituted by, for example, a push button switch or a touch panel.

The voice output unit 46 is a speaker or the like to output sound, and outputs sound when content or the like is reproduced.

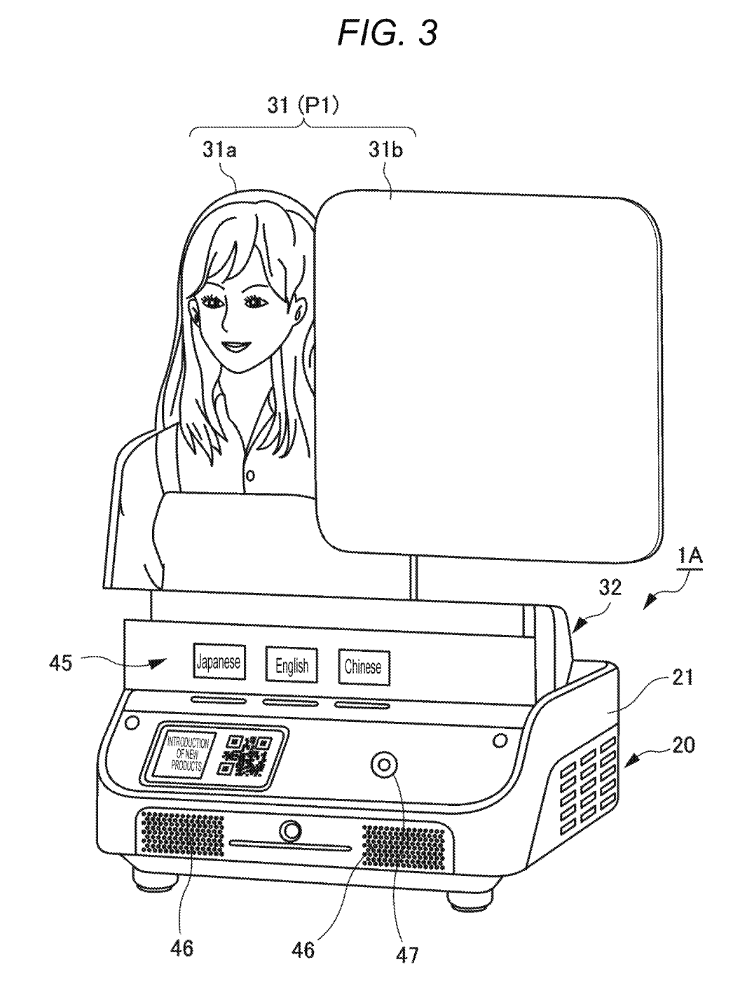

The camera 47 is provided at the front side of the case 20 as illustrated in FIGS. 2 and 3, and photographs an image in front of the first projection apparatus 1A. The photographing range of the camera 47 is set so as to include, at least, a person viewing the image projected on the screen 31 of the first projection apparatus 1A.

The image photographed by the camera 47 is sent to the processor 41, and the processor 41 determines the presence or motion of the person in the image based on image recognition processing.

[Second Projection Apparatus]

The second projection apparatus 2A is capable of projecting, for example, an arbitrary image on a screen, a wall, a floor surface, a ceiling, or the like. In the present embodiment, the second projection apparatus 2A is installed on a ceiling near the installation place of the first projection apparatus 1A as illustrated in FIG. 1, and projects a predetermined guide image on a floor surface (the second surface P2) near the installation place of the first projection apparatus 1A. The second projection apparatus 2A may be installed on a wall near the installation place of the first projection apparatus 1A.

The second projection apparatus 2A starts a projection of an image by receiving the projection start signal from the first projection apparatus 1A, and stops projecting the image by receiving the projection stop signal from the first projection apparatus 1A.

### Operations in the First Embodiment

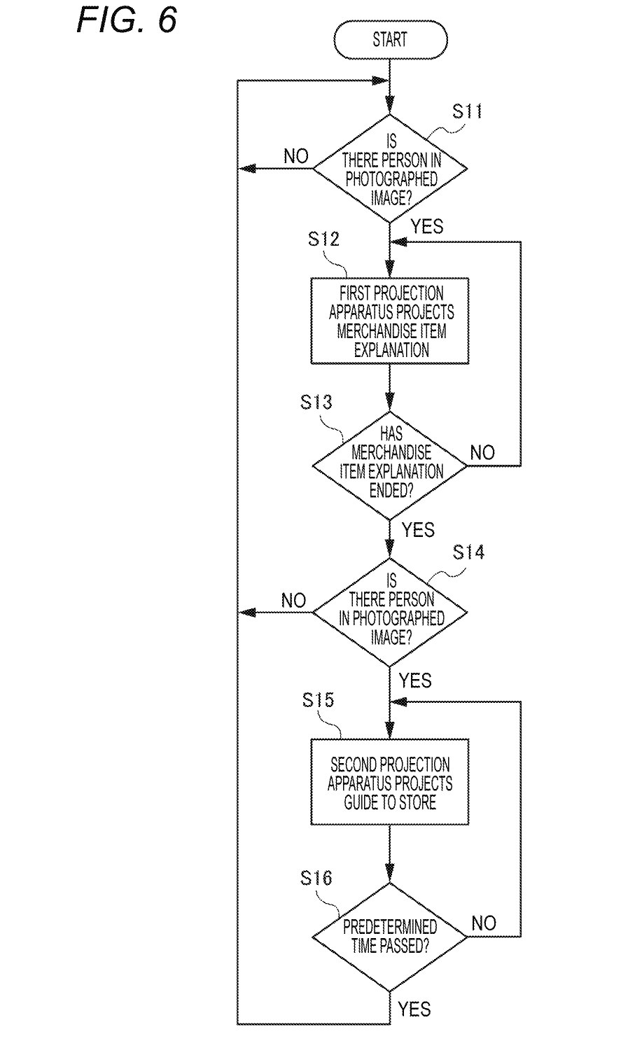

Next, the operations of the projection system 100A according to the first embodiment of the present invention will be described with reference to FIGS. 1 and 6.

The projection system 100A in the first embodiment is installed in a commercial facility, such as a shopping mall, and has functions to display an advertisement of a merchandise item or a service, to distinguish a person interested in the advertisement, and to guide the person to a store where the merchandise item or the service is available.

For example, a case, in which the first projection apparatus 1A installed in a shopping mall displays an explanation of a merchandise item A, and distinguishes a person interested in the merchandise item A, and the distinguished person is guided to a store where the merchandise item A is available with a floor surface display by the second projection apparatus 2A, will be described with reference to the flowchart in FIG. 6.

Specifically, while the first projection apparatus 1A and the second projection apparatus 2A are powered, the processor 41 of the first projection apparatus 1A repeatedly determines whether there is a person in an image photographed by the camera 47 (step S11).

Here, when there is a person in the image (moving image) photographed by the camera 47, for example, when a person stands in front of the first projection apparatus 1A (step S11: YES), the processor 41 of the first projection apparatus 1A projects an explanation image (content related to an advertisement) of the merchandise item A on the screen 31 which is the first surface P1 (step S12). Alternatively, the processor 41 of the first projection apparatus 1A may project the explanation image of the merchandise item A on the screen 31 regardless of whether there is a person in the image (moving image) photographed by the camera 47.

Note that, during the explanation image of the merchandise item A is projected on the screen 31 which is the first surface P1, the projection of the guide image on the second surface P2 illustrated in FIG. 1 is not started.

The explanation image of the merchandise item A is constituted by a moving image and a plurality of still images, and is produced as content lasting, for example, several tens of seconds to several minutes.

Next, the processor 41 of the first projection apparatus 1A determines whether the explanation display of the merchandise item A has been ended (step S13).

Here, when the explanation display of the merchandise item A has been ended (step S13: YES), the processor 41 of the first projection apparatus 1A determines whether there is a person in the image (moving image) photographed by the camera 47 again (step S14).

In other words, the processor 41 of the first projection apparatus 1A determines whether there is a person who has viewed the explanation of the merchandise item A by the first projection apparatus 1A to the last.

Then, it is determined that the person who has viewed the explanation of the merchandise item A to the last is a person interested in the merchandise item A.

Note that, it is determined that the person photographed by the camera 47 when the explanation display of the merchandise item A is ended is a person interested in the merchandise item A in the present embodiment, but in order to exclude a person who coincidentally passes in front of the camera 47 at that timing, a staying time in the image photographed by the camera 47 may be added in the distinguish conditions. Alternatively, it is determined, by a face recognition function, whether a person in the image photographed in step S11 at the time when there is a person in front of the first projection apparatus 1A, and a person in the image photographed in step S14 at the time when the explanation display of the merchandise item A is ended are identical, and when it is determined that the two persons are not identical, the person in the image photographed in step S14 may be determined as a person who is not interested in the merchandise item A.

When there is no person in the image (moving image) photographed by the camera 47 at the end of the explanation of the merchandise item A (step S14: NO), the operation returns back to step S1, and the processor 41 of the first projection apparatus 1A repeatedly determines whether there is a person in the image (moving image) photographed by the camera 47 (step S11).

On the other hand, when there is a person in the image (moving image) photographed by the camera 47 at the end of the explanation of the merchandise item A (step S14: YES), the processor 41 of the first projection apparatus 1A sends the projection start signal to the second projection apparatus 2A, and makes the second projection apparatus 2A project the guide image (step S15).

When receiving the projection start signal from the processor 41 of the first projection apparatus 1A, the second projection apparatus 2A projects a guide image set in advance on a floor surface (a floor surface near the first surface P1) which is the second surface P2.

The guide image is to guide the person interested in the merchandise item A to a store where the merchandise item A is available, includes, for example, the name of the store, and an arrow indicating the direction and the distance to the store as illustrated in FIG. 1, and may further includes the map or route to the store.

By switching the surfaces from the first surface P1 on which the explanation image of the merchandise item A is projected to the second surface P2, which is different from the first surface P1, on which the guide image is projected, it is easy to understand the change of the content of the image, and possible to enhance the recognition of the guide image.

The processor 41 of the first projection apparatus 1A measures a projected time of the guide image by the second projection apparatus 2A, and determines whether the measured time has exceeded a predetermined time (step S16).

When the projected time of the guide image by the second projection apparatus 2A has exceeded the predetermined time (step S16: YES), the processor 41 of the first projection apparatus 1A makes the second projection apparatus 2A stop projecting the guide image, and the operation returns back to step S11.

For example, by sending the projection stop signal to the second projection apparatus 2A, the processor 41 of the first projection apparatus 1A makes the second projection apparatus 2A stop projecting the guide image.

The projection system 100A in the first embodiment is installed in a commercial facility, such as a shopping mall, and can display an advertisement of a merchandise item or a service, distinguish a person interested in the advertisement, and guide the person to a store where the merchandise item or the service is available.

Furthermore, the projection system 100A in the first embodiment uses the camera 47 of the first projection apparatus 1A and further controls the entire projection system 100A by using the processor 41 of the first projection apparatus 1A. Thus, it is possible to simplify the configuration of the projection system 100A compared to the case in which the camera 47 and a processor are separately provided.

### Second Embodiment

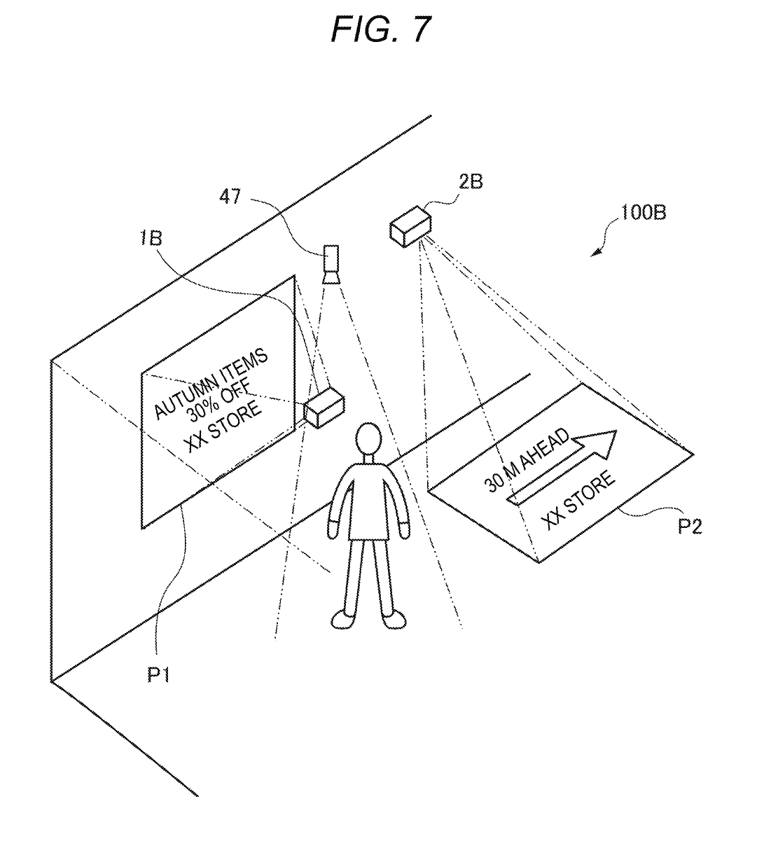

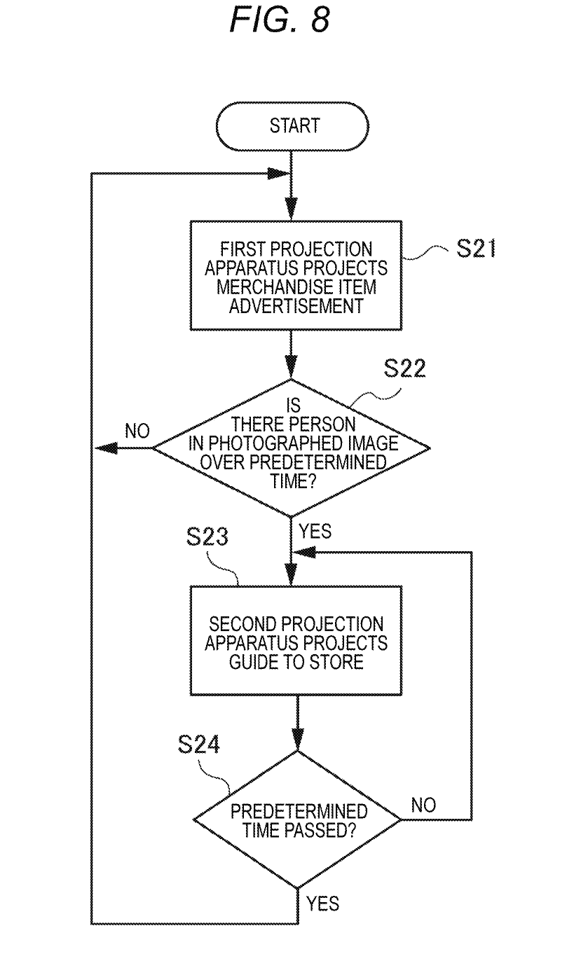

Next, a configuration and operations of a projection system 100B according to a second embodiment of the present invention will be described with reference to FIGS. 7 and 8.

As illustrated in FIG. 7, the projection system 100B in the second embodiment is different from the projection system 100A in the first embodiment in that a first projection apparatus 1B does not include a screen, and projects an image on a wall (a first surface P1), and that a camera 47 to photograph a person viewing a projection image by the first projection apparatus 1B is provided independently from the first projection apparatus 1B.

Note that, the first projection apparatus 1B in the second embodiment includes a processor (not illustrated) equivalent to the processor 41 included in the first projection apparatus 1A in the first embodiment, and the processor controls the first projection apparatus 1B and the entire projection system 100B. Thus, an image photographed by the camera 47 is to be sent to the first projection apparatus 1B.

### Operations in the Second Embodiment

The projection system 100B in the second embodiment is installed in a commercial facility, such as a shopping mall, and has functions to display an advertisement of a merchandise item or a service, to distinguish a person interested in the advertisement, and to guide the person to a store where the merchandise item or the service is available similarly to the projection system 100A in the first embodiment.

For example, a case, in which the first projection apparatus 1B installed in a shopping mall displays sale information on autumn merchandise items, distinguishes a person interested in the sale information on the autumn merchandise items, and guides the distinguished person to a store holding the sale for the autumn merchandise items with a floor surface display by a second projection apparatus 2B, will be described.

As illustrated in FIG. 8, while the first projection apparatus 1B, the second projection apparatus 2B, and the camera 47 are powered, the processor of the first projection apparatus 1B makes the first projection apparatus 1B project a sale information image of autumn merchandise items illustrated in FIG. 7 on a wall which is the first surface P1 (step S21).

Note that, at the time when the projection of the image on the first surface P1 is started, a guide image has not been projected on a second surface P2 in the present embodiment similarly to the first embodiment.

The sale information image of the autumn merchandise items is constituted by a moving image and a plurality of still images, and is produced as content lasting, for example, several minutes.

During the first projection apparatus 1B projects the image, the processor of the first projection apparatus 1B repeatedly determines whether there is a person in the image (moving image) photographed by the camera 47 over a predetermined time or more (step S22).

In other words, the processor of the first projection apparatus 1B determines whether there is a person who are viewing the sale information on the autumn merchandise items projected on the wall by the first projection apparatus 1B over the predetermined time or more.

Then, it is determined that a person satisfying the condition is a person interested in the sale information on the autumn merchandise items.

When there is a person in the image (moving image) photographed by the camera 47 over the predetermined time or more (step S22: YES), the processor of the first projection apparatus 1B sends a projection start signal to the second projection apparatus 2B, and makes the second projection apparatus 2B project the guide image (step S23).

When receiving the projection start signal from the processor of the first projection apparatus 1B, the second projection apparatus 2B projects a guide image set in advance on a floor surface (a floor surface near the first surface P1) which is the second surface P2.

The guide image is to guide the person interested in the sale information on the autumn merchandise items to a store holding the sale, and includes, for example, the name of the store, and an arrow indicating the direction and the distance to the store as illustrated in FIG. 7.

Note that, the projection of the sale information image of the autumn merchandise items on the wall which is the first surface P1 may be ended at the time when the projection of the guide image on the floor surface (the floor surface near the first surface P1) which is the second surface P2 is started. Alternatively, when the sale information image of the autumn merchandise items is not a simple still image but content including a merchandise item explanation, the projection on the first surface P1 may be ended after the end of the explanation.

The processor of the first projection apparatus 1B measures a projected time of the guide image by the second projection apparatus 2B, and determines whether the measured time has exceeded a predetermined time (step S24).

When the projected time of the guide image by the second projection apparatus 2B has exceeded the predetermined time (step S24: YES), the processor of the first projection apparatus 1B makes the second projection apparatus 2B stop projecting the guide image, and the operation returns back to step S21.

### Third Embodiment

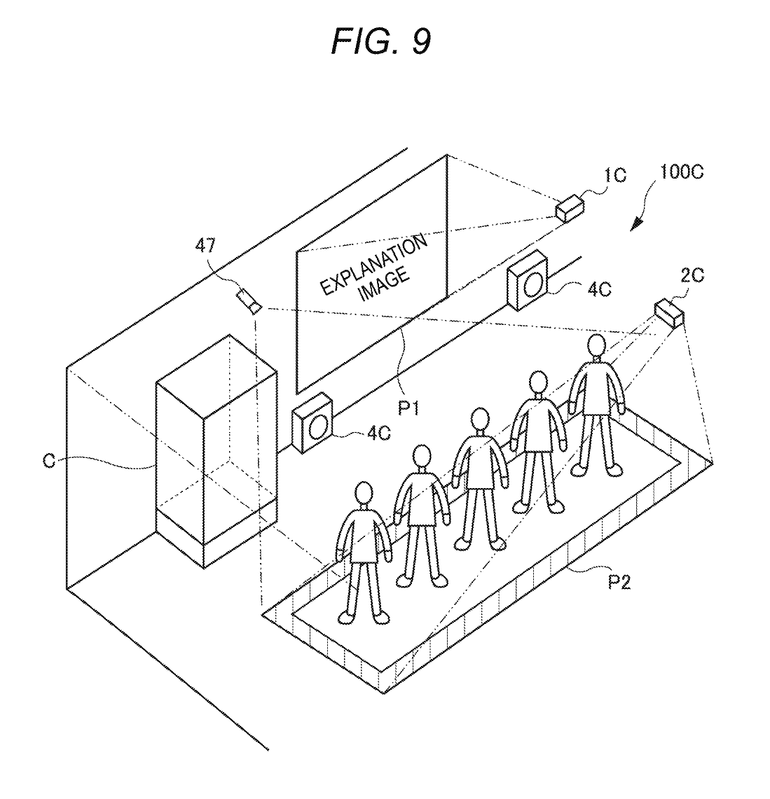

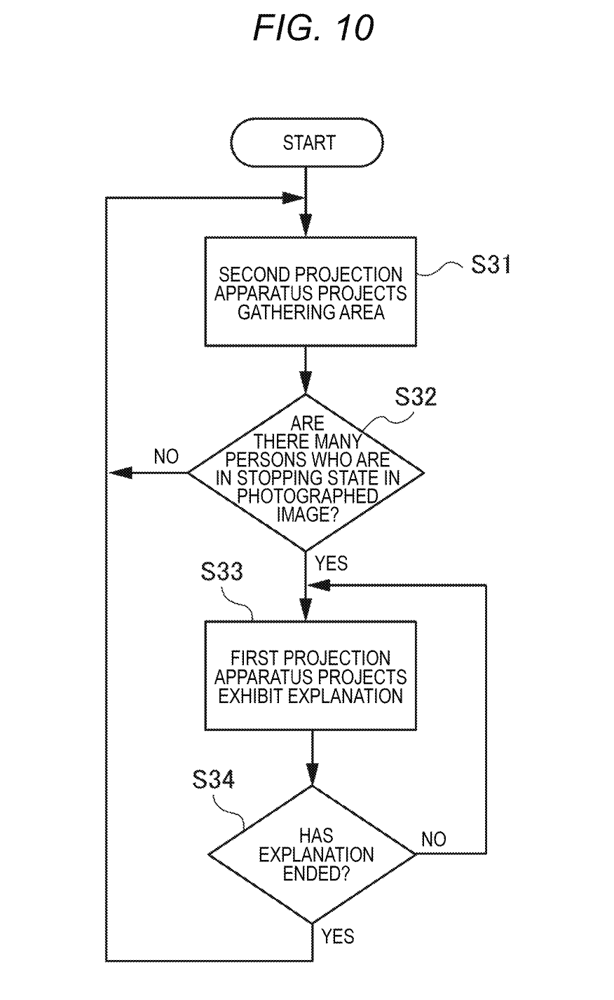

Next, a configuration and operations of a projection system 100C according to a third embodiment of the present invention will be described with reference to FIGS. 9 and 10.

As illustrated in FIG. 9, the projection system 100C in the third embodiment is the same as the projection system 100B in the second embodiment in that a first projection apparatus 1C which projects an image on a wall (a first surface P1) and a second projection apparatus 2C which projects an image on a floor surface (a second surface P2) are included, but is different from the projection system 100B in the second embodiment in that the second projection apparatus 2C projects a gathering area on a floor surface, that a camera 47 photographs presence or motion of gathered persons in the gathering area, and that the first projection apparatus 1C projects an explanation image of an exhibit on a wall for the gathered persons in the gathering area.

Note that, the first projection apparatus 1C in the third embodiment includes a processor (not illustrated) equivalent to the processor 41 included in the first projection apparatus 1A in the first embodiment, and the processor controls the first projection apparatus 1C and the entire projection system 100C. Thus, an image photographed by the camera 47 is to be sent to the first projection apparatus 1C.

### Operations in the Third Embodiment

The projection system 100C in the third embodiment includes a function to automate a series of processing to gather, in a predetermined gathering area, persons who want to view an image to be projected by the first projection apparatus 1C on a wall, to check whether the persons are gathered in the gathering area, and then to start the projection of the image by the first projection apparatus 1C.

For example, a case, in which the projection system 100C installed in an exhibition facility, such as a museum, gathers persons who want to receive an explanation of an exhibit C in a predetermined gathering area (a second surface P2), checks whether the persons are gathered in the gathering area, and makes the first projection apparatus 1C project an explanation image of the exhibit C on a wall (a first surface P1), will be described.

As illustrated in FIG. 10, while the first projection apparatus 1C, the second projection apparatus 2C, and the camera 47 are powered, the processor of the first projection apparatus 1C sends a projection start signal to the second projection apparatus 2C, and makes the second projection apparatus 2C project a gathering area image (step S31).

When receiving the projection start signal from the processor of the first projection apparatus 1C, the second projection apparatus 2C projects a gathering area image set in advance on a floor surface (a floor surface near the first surface P1) which is the second surface P2 as illustrated in FIG. 9.

Note that, it is desirable that a speaker 4C outputs a voice message to prompt persons to gather in the gathering area, such as “The explanation of the exhibit C will be started. Come to the gathering area projected on the floor surface” when the second projection apparatus 2C projects the gathering area image on the floor surface.

Furthermore, at the time when the projection of the gathering area image on the second surface P2 is started, the projection of the image on the first surface P1 has not been started.

During the second projection apparatus 2C projects the image, the processor of the first projection apparatus 1C repeatedly determines whether the number of persons who are in a stopping state is more than a threshold from the data of the image (moving image) photographed by the camera 47 (step S32).

In other words, the processor of the first projection apparatus 1C determines whether the number of gathered persons in the gathering area projected on the floor surface by the second projection apparatus 2C is more than the threshold.

When it is determined that the number of persons who are in the stopping state has exceeded the threshold from the data of the image (moving image) photographed by the camera 47 (step S32: YES), the processor of the first projection apparatus 1C makes the first projection apparatus 1C project the explanation image of the exhibit C on the wall which is the first surface P1 (step S33).

The explanation image of the exhibit C is constituted by a moving image and a plurality of still images, and is produced as content lasting, for example, several minutes.

Note that, the projection of the gathering area by the second projection apparatus 2C may be stopped or continued during the explanation image of the exhibit C is projected.

Next, the processor of the first projection apparatus 1C determines whether the explanation display of the exhibit C has been ended (step S34).

Then, when the explanation display of the exhibit C has been ended (step S34: YES), the operation returns back to the first step S31.

### Fourth Embodiment

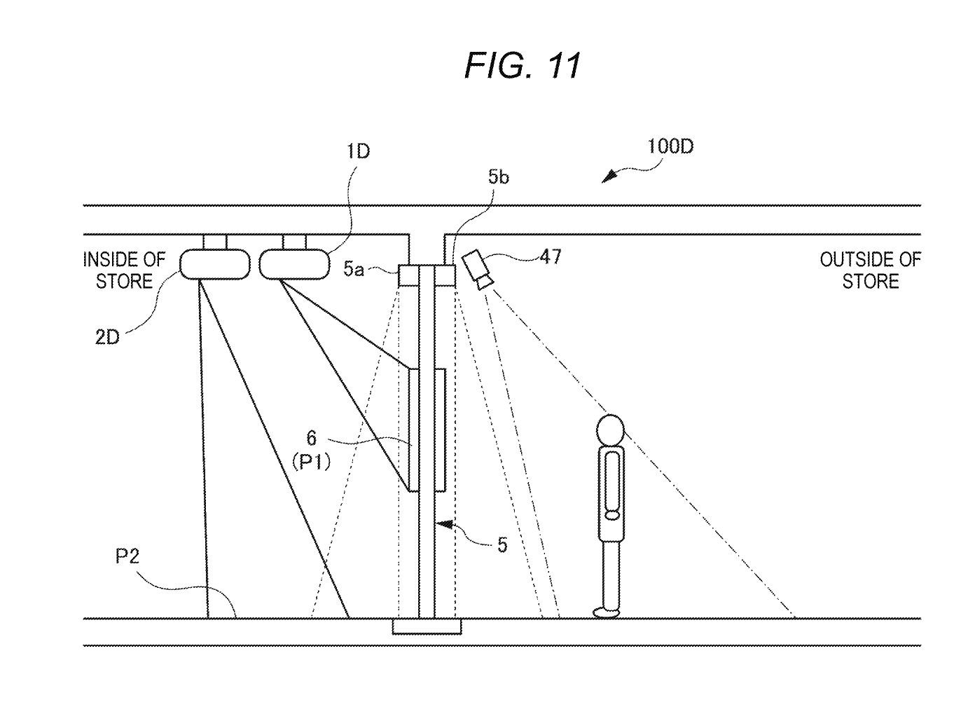

Next, a configuration and operations of a projection system 100D according to a fourth embodiment of the present invention will be described with reference to FIGS. 11 to 13.

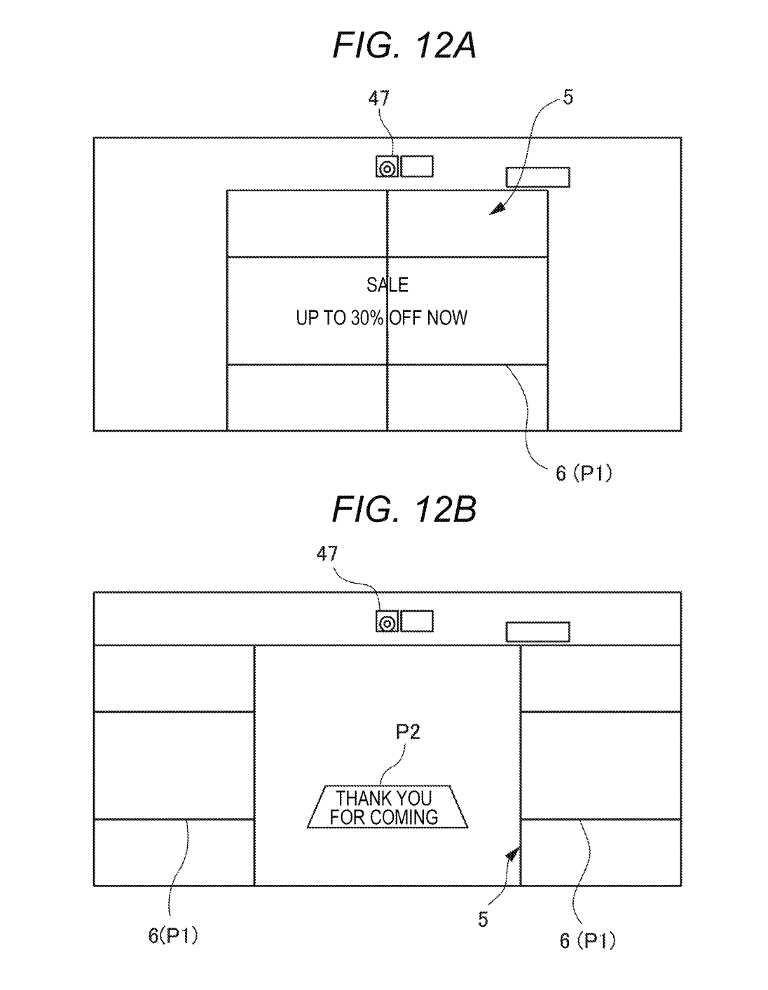

As illustrated in FIGS. 11, 12A, and 12B, the projection system 100D in the fourth embodiment is different from that in the first to third embodiments in that an image is projected on an automatic door 5. Specifically, the projection system 100D is installed on a ceiling inside a store at the entrance of which the automatic door 5 is installed, and includes a first projection apparatus 1D which projects an image on the automatic door 5 (a first surface P1) from the inside of the store, a second projection apparatus 2D which is installed on the ceiling inside the store and projects an image on a floor surface inside the store (a second surface P2), and a camera 47 which is installed on the ceiling inside the store and photographs a person standing in front of the automatic door 5.

The automatic door 5 is automatically opened or closed in response to human detection by human sensors 5a and 5b which are provided inside and outside the store respectively.

The photographing area of the camera 47 is adjusted so as to photograph a person who is standing at a position farther than the human detection area of the outside human sensor 5b from the automatic door 5.

Furthermore, a rear-projection film screen 6 is stuck on the inside surface of the automatic door 5, and the image projected on the automatic door 5 by the first projection apparatus 1D from the inside of the store is viewed from the outside of the store through the rear-projection film screen 6.

For example, a projection film (cyberview screen) manufactured by Mapro Co., Ltd (Korea) and sold by Cyber-Reps Corporation (Japan) can be used as the rear-projection film screen 6.

Note that, the first projection apparatus 1D in the fourth embodiment includes a processor (not illustrated) equivalent to the processor 41 included in the first projection apparatus 1A in the first embodiment, and the processor controls the first projection apparatus 1D and the entire projection system 100D (including forced opening control of the automatic door 5). Thus, an image photographed by the camera 47 is to be sent to the first projection apparatus 1D.

### Operations in the Fourth Embodiment

The projection system 100D in the fourth embodiment is installed near an entrance of a store where the automatic door 5 is installed, and have functions to display an advertisement of a merchandise item or a service, to distinguish a person interested in the advertisement, and guide the person to the inside of the store.

For example, a case, in which the first projection apparatus 1D displays sale information on the automatic door 5, distinguishes a person interested in the sale information, and guides the distinguished person to the inside of the store with an opening operation of the automatic door 5 or with a floor surface display by a second projection apparatus 2D, will be described.

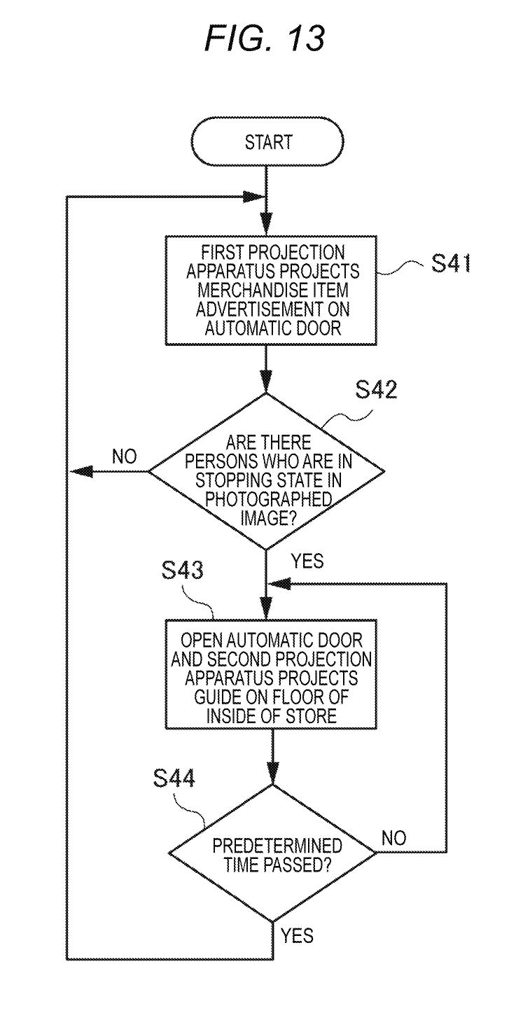

While the first projection apparatus 1D, the second projection apparatus 2D, the camera 47, and the automatic door 5, which are illustrated in FIG. 11, are powered, the processor of the first projection apparatus 1D projects a sale information image on the automatic door 5 which is the first surface P1 as illustrated in FIG. 13 (see step S41: FIG. 12A).

The sale information image is constituted by a moving image or a still image, and a still image consisting of the string of letters of “SALE. UP TO 30% OFF NOW” is projected on the automatic door 5 as the sale information image in the example illustrated in FIG. 12A.

During the first projection apparatus 1D projects the image, the processor of the first projection apparatus 1D repeatedly determines whether there is a person who is in a stopping state from the data of the image (moving image) photographed by the camera 47 (step S42).

In other words, the processor of the first projection apparatus 1D determines whether a person is paying attention to the sale information projected on the automatic door 5 by the first projection apparatus 1D.

Then, it is determined that a person satisfying the condition is a person interested in the sale information.

When it is determined that there is a person who is in the stopping state from the data of the image photographed by the camera 47 (step S42: YES), the processor of the first projection apparatus 1D sends a forced opening start signal to a processor (not illustrated) of the automatic door 5, and sends a projection start signal to the second projection apparatus 2D (step S43).

In other words, when there is a person stopping in the photographing area of the camera 47 although the person is out of the human detection area of the outside human sensor 5b of the automatic door 5, the processor of the first projection apparatus 1D makes the automatic door 5 open and the second projection apparatus 2D project a guide image on the floor surface inside the store, and thereby guides the person to the inside of the store (see FIG. 12B).

For example, in the example illustrated in FIG. 12B, the still image consisting of the string of letters of “Thank you for coming” is projected on the floor surface inside the store as the guide image.

Note that, it is more easily recognized that the projection of the display of the string of letters of “Thank you for coming” is started at the moment when the automatic door 5 starts to open than at the time when the automatic door 5 is almost fully opened, for example, when the automatic door 5 is opened at about 80%, and it is possible to enhance visual effects.

The processor of the first projection apparatus 1D measures a projection time of the guide image by the second projection apparatus 2D while making the automatic door 5 open, and determines whether the measured time has exceeded a predetermined time (step S44).

When the measured time has exceeded the predetermined time (step S44: YES), the processor of the first projection apparatus 1D sends an opening stop signal to the automatic door 5, and a projection stop signal to the second projection apparatus 2D, and then the operation returns back to the first step S41.

The present invention has been described with reference to the specific embodiments, but is not limited to the above described embodiments, and various change or modifications can be made.

For example, the first projection apparatus 1A to 1D (the first projection unit) which project an image on the first surface P1 and the second projection apparatus 2A to 2D (the second projection unit) which project an image on the second surface P2 are separately provided in the above embodiments, but image light from a projection apparatus (a projection unit) may be projected on the first surface P1 or the second surface P2 by switching the surfaces.

Such a projection surface switching unit can be constituted by using, for example, a movable reflection mirror mechanism capable of switching reflection angles of image light.

Furthermore, the number of projection units or projection surfaces may be three or more, and the projection surface is not limited to a floor surface or a wall, and may be a ceiling surface, and appropriately determined as needed.

What is claimed is:

1. A projection system comprising:
an imaging unit configured to photograph a predetermined region;
a projection unit configured to project an image on a first surface and a second surface different from the first surface; and
a processor configured to control a projection by the projection unit based on a state of a person photographed by the imaging unit.

2. The projection system according to claim 1, wherein
the projection unit comprises:
a first projection unit configured to project an image on the first surface; and
a second projection unit configured to project an image on the second surface.

3. The projection system according to claim 1, wherein
the projection unit is constituted by a projection unit, and comprises a projection surface switching unit configured to project projection light from the projection unit on the first surface or the second surface by switching the first surface and the second surface.

4. The projection system according to claim 1, wherein
the projection unit projects content related to an advertisement on the first surface, and starts a projection of an image on the second surface when an image photographed by the imaging unit includes a person at an end of reproduction of the content.

5. The projection system according to claim 2, wherein
the projection unit projects content related to an advertisement on the first surface, and starts a projection of an image on the second surface when an image photographed by the imaging unit includes a person at an end of reproduction of the content.

6. The projection system according to claim 3, wherein
the projection unit projects content related to an advertisement on the first surface, and starts a projection of an image on the second surface when an image photographed by the imaging unit includes a person at an end of reproduction of the content.

7. The projection system according to claim 1, wherein
the projection unit starts a projection of an image on the second surface when an image photographed by the imaging unit includes a person after a predetermined time passes from a start of a projection of an image on the first surface.

8. The projection system according to claim 2, wherein
the projection unit starts a projection of an image on the second surface when an image photographed by the imaging unit includes a person after a predetermined time passes from a start of a projection of an image on the first surface.

9. The projection system according to claim 3, wherein
the projection unit starts a projection of an image on the second surface when an image photographed by the imaging unit includes a person after a predetermined time passes from a start of a projection of an image on the first surface.
